(19) United States
(12) Patent Application Publication
(10) Pub. No.: US 2014/0029436 A1
(43) Pub. Date: Jan. 30, 2014

(54) Method And Device For Optimizing The Routing Of A Stream

(71) Applicants: Michael Boc, Clamart (FR); Christophe Janneteau, Chaudon (FR); Alexandru Petrescu, Orsay (FR)

(72) Inventors: Michael Boc, Clamart (FR); Christophe Janneteau, Chaudon (FR); Alexandru Petrescu, Orsay (FR)

(73) Assignee: Commissariat a L'energie atomique et aux energies alternatives, Paris (FR)

(21) Appl. No.: 14/110,430

(22) PCT Filed: Mar. 28, 2012
(86) PCT No.: PCT/EP12/55545

§ 371 Date: Oct. 7, 2013

(30) Foreign Application Priority Data
Apr. 7, 2011 (FR) 1153022

(51) Int. Cl. H04L 12/803

(52) U.S. Cl. CPC H04L 47/125
USPC 370/236

(57) ABSTRACT

A method for optimisation of the routing of a flow exchanged between two nodes in an operator's telecommunications network.

This method includes a step which involves re-routing said flow via at least one intermediate server arranged between said nodes and which is capable of applying at least one treatment that is pre-defined by the operator to said flow.

### TECHNICAL FIELD

The invention is in the field of telecommunications networks and more specifically concerns a method and a device for optimising the routing of a flow exchanged between two nodes in a telecommunications network wherein, during a connection to the network, each node connects to an access router linked to a central entity capable of defining a path for said flow.

The invention applies particularly but not exclusively in a Proxy Mobile IPv6 (PMIPv6) and/or Mobile IPv4/NEMOv4 and/or Mobile IPv6/NEMOv6 domain.

### THE STATE OF THE PRIOR ART

In a telecommunications network such as the Internet, the purpose of a mobility management protocol is to manage the movement of mobile items of equipment and to prevent their communications being lost when they change their access point to the network. In fact, without a mobility management protocol, the IPv6 address (the Internet identifier) of a client is likely to change on each (re)-connection to the network. Since a communication is explicitly defined by a software interface (called a socket), which is fixed between two IPv6 addresses, any communication will therefore be lost if one of the addresses changes.

The IETF (Internet Engineering Task Force) specifies the PMIPv6 (Proxy Mobile IPv6) mobility management protocol, according to which the entire mobility management of clients is carried out solely through the network. The management is therefore transparent for the clients. Other protocols such as MIPv6 (Mobile IPv6) require active participation by clients, which consists, for example, of exchanging signal messages with the entities which make up the mobility management protocol.

In the remainder of this document, we will use the term node to designate an item of equipment of a client which connects to the network such as, for example, a portable computer, a telephone or any equipment capable of communicating via the network.

FIG. 1 diagrammatically shows an architecture which allows the mobility of nodes 4 to 6 to be managed in a network which uses the PMIPv6 protocol. In this architecture, when nodes 4 and 6 connect to the network, they are then respectively associated with an IP access router called MAG 8 (Mobile Access Gateway) and an IP access router called MAG 10. MAG 8 and 10 and all the other MAGs to which nodes 4 and 6 connect during a session will always emulate the same access (same IP address, same signal message etc.) in order to make any change of association at the IP level transparent. To this end, each MAG 8 and 10 stores the position of the node which it is associated with by sending a PBU (proxy binding update) message to a central entity called the LMA (Local Mobility Anchor) 12. This central entity in return sends a PBA (proxy binding acknowledgement) message to the MAG 8 (respectively 10) to validate the taking over of this node and assigns it an IPv6 address which will remain valid as long as the communication session remains active. All communications to and from this node therefore pass through a bidirectional tunnel 14, 16 respectively, that the LMA 12 and the MAG 8 (respectively 10) establish between each other.

Because in this architecture all communications in the PMIPv6 domain pass through the LMA 12, it may happen that the flow(s) between two close nodes undergo a large detour by passing through a distant LMA. It is therefore desirable to optimise routing of traffic between nodes.

The document “Localized Routing for Proxy Mobile IPv6, draft-ietf-netext-pmip-Ir-01 October 2010” describes a set of methods for optimising routing by establishing a direct tunnel between the MAGs of the nodes.

With this type of approach the flows exchanged between the nodes no longer pass through the LMA 12. It therefore becomes difficult to supply high-added-value customised services to the nodes such as quality of service, or it is difficult to put in place the operator's own services which require access to the flow (e.g. legal interception, inspection of traffic and verification of its compliance with the contract etc.) since these treatment services are localised in the LMA. This means that overall the operator loses flexibility.

The document “Internet Protocol, DARPA Internet Program Protocol Specification.” RFC791. September 1981 describes the “source routing” method, which is a technique developed in the IPv4 specification as well as in the IPv6 specification through the routing header (type 0) described in the document “Internet Protocol, Version 6 (IPv6) Specification.” RFC2460, December 1998. This method allows a source node to partially or fully define a sequence of routers that a flow must pass through to reach a destination node.

A major drawback with this method comes from the fact that the flows exchanged are not secured, insofar as the definition of the routers' sequence is not controlled by the operator.

One aim of the invention is to compensate for the disadvantages of the prior art described above.

### PRESENTATION OF THE INVENTION

The aims of the invention are achieved using a mechanism which forces a flow of data to pass through one or more intermediate servers when a routing optimisation method is initiated, in particular in a network which uses the Proxy mobile IPv6 protocol and/or the IPv4/NEMOv4 Mobile protocol and/or the IPv6/NEMOv6 Mobile protocol. This is achieved by a method for optimising the routing of a flow exchanged between two nodes in a telecommunications network, wherein during a connection to the network each node connects to an access router linked to a central entity capable of defining a path for said flow.

The method according to the invention includes a step which involves re-routing said flow under the control of the operator so as to make said flow pass via at least one intermediate server selected by the operator and preventing said flow systematically passing through said central entity.

The method according to the invention allows the operator to have control over traffic. The former may thus choose to de-route traffic into a less overloaded zone of the network and/or apply specific treatments to it (e.g. filtering, monitoring, reservation of resources, tariff application etc.).

According to another characteristic of the invention, each intermediate server is arranged between said nodes and is capable of applying at least one treatment that is pre-defined by the operator to said flow.

According to one preferred embodiment, said pre-defined treatment includes at least one of the following functions:
filtering the contents of said flow,
applying a tariff system to the various components of the flow
measuring the bandwidth used,
providing differentiated quality of service, depending on the client or on the type of flow.
Analysing the flow contents (for legal monitoring, for example).

The method according to the invention includes a phase involving selection, by the operator, of the treatments to be applied to the flow and of one or more intermediate servers capable of applying said treatments, and a phase for configuration of optimised routing of this flow, depending on the pre-defined treatments.

An intermediate server may be a simple router, a MAG, a server, a proxy or any other entity which can divert traffic and/or apply a specific treatment to a flow.

It should be noted that the flow may be re-routed through several intermediate servers in a chain. In this case, one of said servers may be an LMA.

In the method according to the invention, configuration of the routing involves creating, on each intermediate server, the inputs and outputs of at least one tunnel by sending each intermediate server a signal message which includes information on the IP addresses of the nodes, the prefix(es) of the source and destination nodes, the identifiers of said source and destination nodes as well as the IP address of the previous server and the IP address of the following server.

Furthermore, during a connection to the network, at least one node connects to an access router connected to a central entity which is capable of defining, for each access router, a routing table which is optimised according to the treatments pre-defined by the operator in each intermediate server.

In a first variant the method according to the invention is applied in an IP type network with fixed access routers.

In a second variant the method according to the invention is applied in an IP type network with mobile access routers.

In both variants the central entity creates the inputs and outputs of the tunnels on each intermediate server by sending each intermediate server a signal message including information on the IP addresses of the nodes, the prefix(es) of the source and destination nodes, the identifiers of said source and destination nodes as well as the IP address of the previous server and the IP address of the following server. Said central entity retransmits said signal message if no response is received during a pre-defined waiting time.

The method according to the invention is implemented by a device which includes means for re-routing said flow via one or more intermediate servers configured to apply at least one treatment which is pre-defined by the operator to said flow, and in which each intermediate server includes at least one module which carries out at least one of the following functions, which are given as non-restrictive examples:
filtering the contents of the flow,
application of a tariff system to the various components of the flow,
measurement of the bandwidth used,
provision of differentiated quality of service, depending on the client or on the type of flow.
Analysing the flow contents (legal monitoring, for example).

This device furthermore includes a central entity capable of creating the inputs and outputs of at least one tunnel on each intermediate server by sending each intermediate server a signal message which includes information on the IP addresses of the nodes, the prefix(es) of the source and destination nodes, the identifiers of said source and destination nodes as well as the IP address of the previous server and the IP address of the following server.

The steps in the method according to the invention are carried out by computer programme instructions stored on a support medium when it is executed by a computer.

### BRIEF DESCRIPTION OF THE DRAWINGS

Other characteristics and advantages of the invention will emerge from the following description, given as a non-restrictive example, with reference to the appended figures in which:

FIG. 1, described previously, diagrammatically shows an architecture which allows the mobility of two nodes in a network which uses the PMIPv6 protocol to be managed,

FIG. 2 shows a first embodiment variant of the invention in a PMIPv6 domain.

FIG. 3 diagrammatically shows a second embodiment variant of the invention in a PMIPv6 domain.

FIG. 4 diagrammatically shows a third embodiment variant of the invention in a PMIPv6 domain.

FIG. 5 diagrammatically shows a fourth embodiment variant of the invention in a Mobile IPv4/NEMOv4 or Mobile IPv6/NEMOv6 domain.

FIG. 6 shows the routing configuration method according to the invention, for a flow exchanged, via two intermediate servers, between two nodes,

FIG. 7 shows the updating of tunnels established between the nodes during the routing configuration method in FIG. 6,

FIG. 8 diagrammatically shows one embodiment of the invention in the case where the nodes which are exchanging the data flow are assigned to different LMAs.

FIG. 9 shows the exchanges of messages between the various elements of FIG. 8 in order to achieve optimised routing,

FIG. 10 diagrammatically shows the format of a LRI message,

FIG. 11 shows an example of the organisation of options according to the invention, for determining how to create its two tunnels,

FIG. 12 diagrammatically shows the format of a LRA message,

FIG. 13 shows the steps for optimising the routing between two NEMOv6 mobile routers.

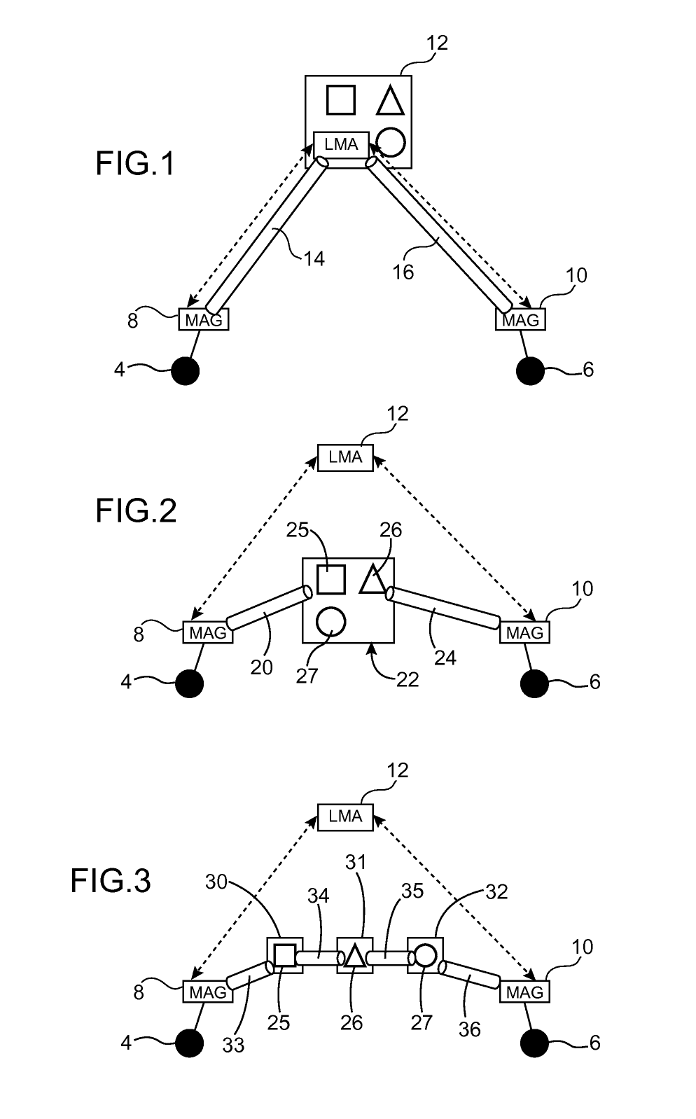

### DETAILED DESCRIPTION OF PARTICULAR EMBODIMENTS

The invention will be described, with references to FIGS. 2-8, for optimising the routing of a flow of multi-media data exchanged, via a network using the PMIPv6 protocol, between a source node and a destination node. In the description that follows, the elements common to the different figures will be designated by the same references.

FIG. 2 shows a first embodiment variant of the invention in a PMIPv6 domain wherein two topologically close nodes, that, is a source node 4 and a destination node 6, are respectively associated with a MAG 8 and a MAG 10 during an IP session. In this case a first tunnel 20 is established between the MAG 8 of the source node 4 and an intermediate server 22 and a second tunnel 24 is established between this intermediate server 22 and the MAG 10 of the destination node 6. The intermediate server 22 is configured so as to apply a set of pre-defined services imposed by requirements, for example legal and/or economic or other requirements, to the flows exchanged between the nodes 4 and 6. Thus, for example, the intermediate server 22 includes a first module 25 which is intended to apply a certain level of quality of service, a second module 26 intended to apply filtering of the traffic in order to block any inadmissible content, and a third module 27 intended to duplicate the flow in order to carry out surveillance of voice communications, for example.

FIG. 3 diagrammatically shows a second embodiment variant of the invention in a PMIPv6 domain wherein the first, second and third modules 25, 26 and 27 are not hosted on the same intermediate server. In this case the first module 25 is hosted on a first intermediate server 30, the second module 26 is hosted on a second intermediate server 31, and the third module 27 is hosted on a third intermediate server 32. In order that module may apply its treatment to the flow, four tunnels 33, 34, 35 and 36 are established on the path that this flow must follow between, respectively, the MAG 8 and the first intermediate server 30, the first intermediate server 30 and the second intermediate server 31, the second intermediate server 31 and the third intermediate server 32, the third intermediate server 32 and the MAG 10. It should be noted that in this variant at least one of the intermediate servers 30, 31 and 32 may be an LMA.

Naturally, the flow may be re-routed to one or several intermediate servers which can provide a given service or several difference services.

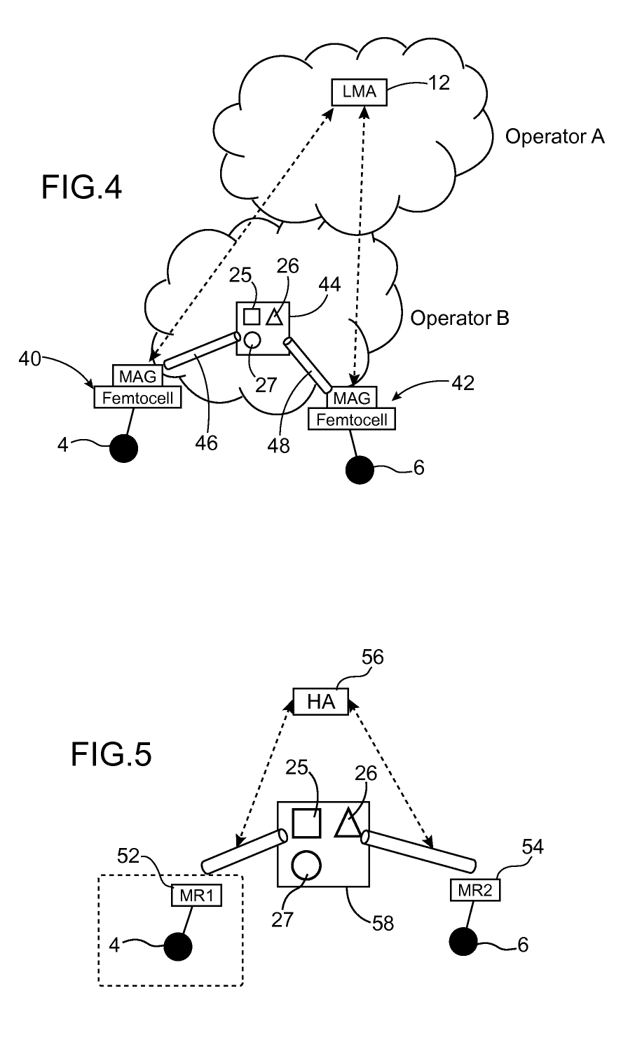

FIG. 4 diagrammatically shows a third embodiment variant of the invention in a PMIPv6 domain wherein the nodes are connected through femtocells or residential Wi-Fi routers. A femtocell is an access point which provides cellular connectivity with a very limited scope (an apartment, one floor of an office etc.) and which sends traffic to the owner operator of the femtocell through an internet connection. The path taken by the data between a femtocell and the owner cellular operator may pass through a series of networks belonging to other operators.

In another embodiment variant of the invention shown in FIG. 4, a femtocell is considered to be a combination of a cellular access point and an MAG. In this case optimised routing between two femtocells may, in certain circumstances, not pass through the operator's network. In this scenario the owner operator of the femtocells installs an intermediate server in the network of another operator close to the nodes. The traffic between two nodes may then be re-routed through this intermediate server.

Thus with reference to FIG. 4, two nodes 4 and 6 attached respectively to two femtocells 40 and 42 of an operator A are exchanging a multimedia flow. In order to optimise the routing of the flow being exchanged between these nodes, the flow is re-routed from the femtocell 40 through a first tunnel 46 towards an intermediate server 44 hosted in the network of an operator B, then transmitted from the intermediate server 44 towards the second femtocell 42 through a second tunnel 48. Thus the flow does not pass through the LMA 12, operator A may then apply the treatments programmed in the intermediate server 44 to this flow.

FIG. 5 diagrammatically shows a fourth embodiment variant of the invention in a Mobile IPv4/NEMOv4 or Mobile IPv6/NEMOv6 domain wherein the nodes 4 and 6 connect through an intermediate server 58 used as crossing point for the direct traffic between two mobile routers 52 and 54.

It should be recalled that a mobile router is an item of equipment which is equipped with several network interfaces which moves around with a set of other items of equipment and manages the mobility of this set of items of equipment. These latter are not affected by mobility events. This is the case, for example with a mobile router installed on a train which connects to the Internet with an LTE (Long Term Evolution) interface, and which provides access to the network for passengers' equipment through its Wi-Fi interface; with the passengers' equipment not implementing a mobility protocol.

With reference to FIG. 5, a HA (Home Agent) 56 fulfils the function of the LMA 12 for MAG 8 and 10 for the routers 52, 54. Using this analogy, the traffic between the two Mobile Routers 52 and 54 may be re-routed through one or more intermediate servers, thus avoiding having to pass through the Home Agent 56. This may offer the flow a shorter route than the passage through the HA 56. Furthermore, although it is not the shortest path, that is, the direct path between the routers 52 and 54, passing through the intermediate servers 58 has the advantage of providing the network operator with the possibility of augmenting the services offered by applying the treatments programmed into this intermediate server 56 to the flow.

In the various embodiment variants of the invention, the application of the optimisation method according to the invention includes the following three phases:
Detection of the need to optimise the routing for a data flow,
Selection of the services to be applied to the flow and of the associated servers through which the flow must pass to achieve an optimised routing,
Configuration of the optimised routing for this flow.

Detection of the need to optimise the routing is the result, for example, of the fact that a LMA or a HA of a destination node receives a first data packet which indicates that communication is established.

The operator may also only configure the optimised routing if the node or nodes will not be mobile for a certain period of time by using a prediction algorithm.

The operator may also decide to only allow optimised routing for a certain type of traffic and again only after a certain time has elapsed.

It should be noted that irrespective of which element is initiating the routing optimisation method, the operator can modify or deactivate an optimised path at any time. The operator must indicate at the LMA configuration, or in a dynamic manner, a list of intermediate servers, their IPv6 addresses and the services that each of them provides. These servers must be authenticated by the LMA. The list of services to be applied to a flow, and therefore the list of intermediate servers to pass through, can depend on the operator's choice and/or on the options that each client subscribes to.

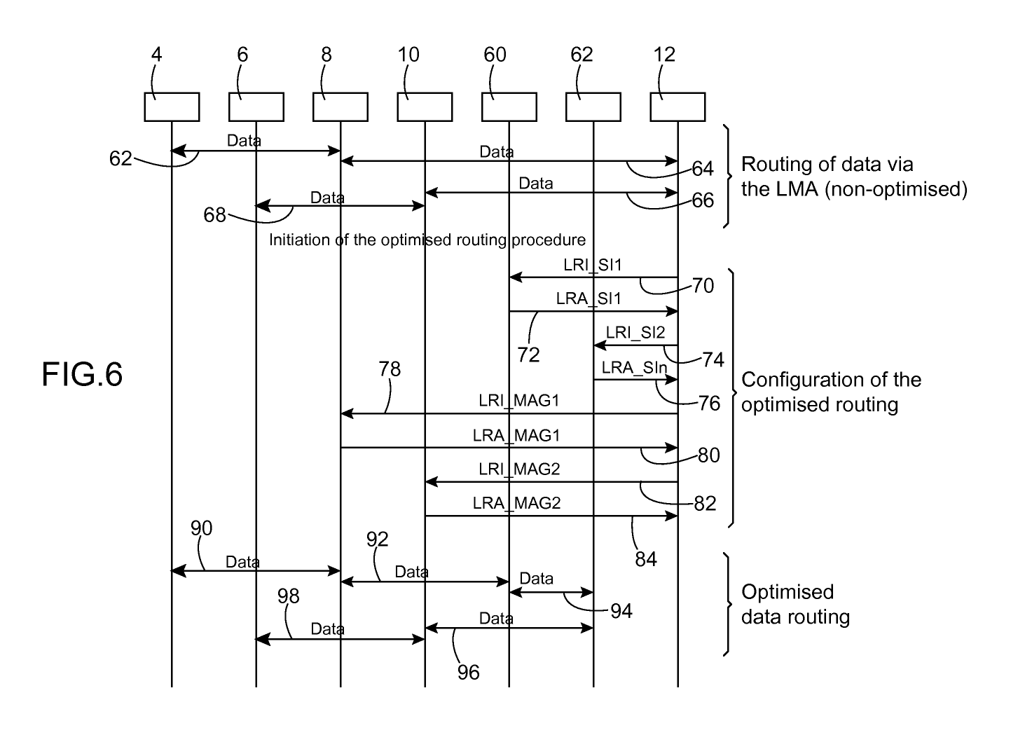

The optimised routing configuration phase will now be described with reference to FIGS. 6-9.

The first step in this phase involves creating the inputs and outputs of the tunnels on each intermediate server, with information on the IPv6 addresses of the nodes as parameters. In order to do this the LMA or the HA will initiate the creation of a tunnel by sending a “localized routing initiation” or LRI signal message to each intermediate server. An LRI message will indicate the prefix(es) of the source and destination nodes, their identifiers, as well the IPv6 address of the previous server and the IPv6 address of the following server (MAG or intermediate server), and if appropriate the prefix of the nodes served by the mobile routers. Each intermediate server returns a “localized routing acknowledgement” validation message or LRA.

FIG. 6 shows the routing configuration method for a flow exchanged, through two intermediate servers 60, 62, between the source node 4 and the source node 6 associated respectively with the first MAG 8 and the second MAG 10 during a session in a network which includes the LMA 12.

The steps 62 to 68 show the data exchanges before routing optimisation.

At step 62 the source node 4 sends the flow to the MAG 8 with which it is associated during the session.

At step 64 the MAG 8 sends the flow to the LMA 12. The latter sends said flow to the MAG 10 which sends it to the destination node 6.

Steps 70 to 84 show the optimised routing configuration phase according to the invention.

At step 70, the LMA 12 sends a message LRI_SI60 to the intermediate server 60 indicating to it the prefix(es) of the source 4 and destination 6 nodes, their identifiers as well as the IPv6 address of the intermediate server 62.

At step 72, the intermediate server 60 sends the LMA 12 a message LRA_SI60 acknowledging receipt.

At step 74, the LMA 12 sends a message LRI_SI62 to the intermediate server indicating to it the prefix(es) of the source 4 and destination 6 nodes, their identifiers as well as the IPv6 address of the MAG 10 and the IPv6 address of the intermediate server 60.

At step 76, the intermediate server 60 sends the LMA 12 a message LRA_SI62 acknowledging receipt.

Once the tunnel input and output points are established on the intermediate servers 60, 62, the LMA 12 creates tunnel input and output points on MAGs 8 and 10. An input/output point will be created on the first MAG 8 to the first intermediate server 60 and on the second MAG 10 to the second intermediate server 62 in accordance with the following steps.

At step 78, the LMA 12 sends a message LRI_MAG8 to the MAG 8 indicating to it the prefix(es) of the source 4 and destination 6 nodes, their identifiers as well as the IPv6 address of the intermediate server 60.

At step 80, the MAG 8 sends the LMA 12 a message LRA_MAG8 acknowledging receipt.

At step 82, the LMA 12 sends a message LRI_MAG10 to the MAG 10 indicating to it the prefix(es) of the source 4 and destination 6 nodes, their identifiers as well as the IPv6 address of the intermediate server 62.

At step 84, the MAG 10 sends the LMA 12 a message LRA_MAG10 acknowledging receipt.

The steps 90 to 98 show the data exchanges after routing optimisation.

At step 90 the source node 4 sends the flow to the MAG 8. At step 92 the latter transfers the flow received to the intermediate server 60 via the tunnel configured during the previous phase.

At step 94, the intermediate server 60 sends the flow received to the intermediate server 62. At step 96 the latter transfers the flow received to the MAG 10 via the tunnel configured during the previous phase.

At step 98 the MAG 10 sends the flow to the destination node 6.

It should be noted that the sequence for sending the LRI messages can take place according to a different timing without going beyond the scope of the invention. In effect, LMA 12 may be configured, for example, to send LRI messages to the MAGs 8 and 10 before sending them to the intermediate servers 60, 62 or even to send everything in parallel. Nevertheless the sequence shown in FIG. 6 which involves configuring the intermediate servers 60, 62 then the MAGs 8, 10 is preferred since it ensures availability and proper configuration of all the intermediate servers which form the optimised routing path before configuring the MAGs so that the data flow takes this optimised routing path.

It will also be noted that as long as the MAGs 8 and 10 are not configured with the optimised routing information contained in the LRI messages, the data flow continues to be routed through the LMA 12, thus avoiding any potential interruption of services during the phase of configuration of the intermediate servers 60, 62.

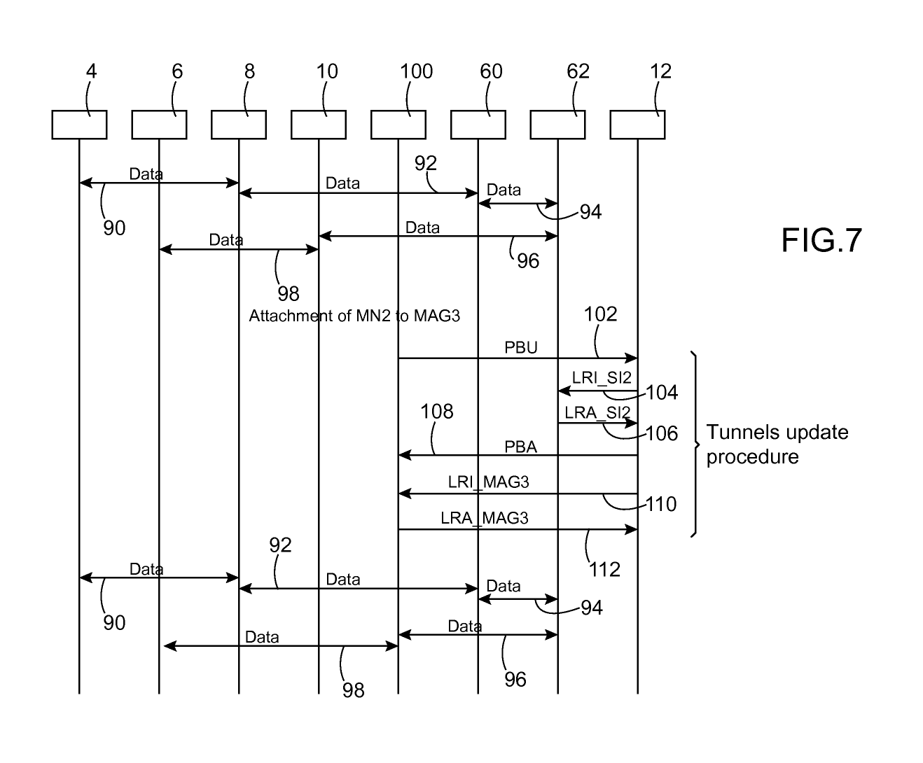

In a particular case of implementation of the invention, when the source node 4 moves from the MAG 8 to a new MAG 100, that is, during, for example, a change of association of the node 4 due to a movement within the network, the new MAG 100 stores the position of the node at the LMA 12, and on reception of the PBU (proxy binding update) signal message the updating of the tunnels follows the method described by the FIG. 7.

In FIG. 7, steps 90 to 98 are those described with reference to FIG. 6.

At step 102, the new MAG 100 transmits a PBU (proxy binding update) to the LMA 12 in order to store the new position of the node 6.

At step 104 the LMA sends a message LRI_SI62 to the second intermediate server 62 with the IPv6 address of the MAG 100 to which the node 6 is now connected, so that the intermediate server 62 updates its routing configuration in such a way that the traffic addressed to node 6 is now tunnelled to the MAG 100 (rather than the MAG 8 as initially).

At step 106, the second intermediate server 62 sends the LMA 12 a message LRA_SI62 acknowledging receipt.

At step 108, the LMA 12 sends in return a PBA (proxy binding acknowledgement) message to the new MAG 100.

At step 110, the LMA 12 sends a message LRI_MAG100 to the new MAG 100 indicating to it the prefix(es) of the nodes 4 and 6, their identifiers as well as the IPv6 address of the intermediate server 62. This is done so that the new MAG 100 implements the optimised routing via the intermediate server 62.

At step 112, the new MAG 100 sends the LMA 12 a message LRA_MAG100 acknowledging receipt.

After the update of the tunnels described by the steps 102 to 112, the new MAG 100 replaces the MAG 8 in steps 90 to 98 of the optimised routing.

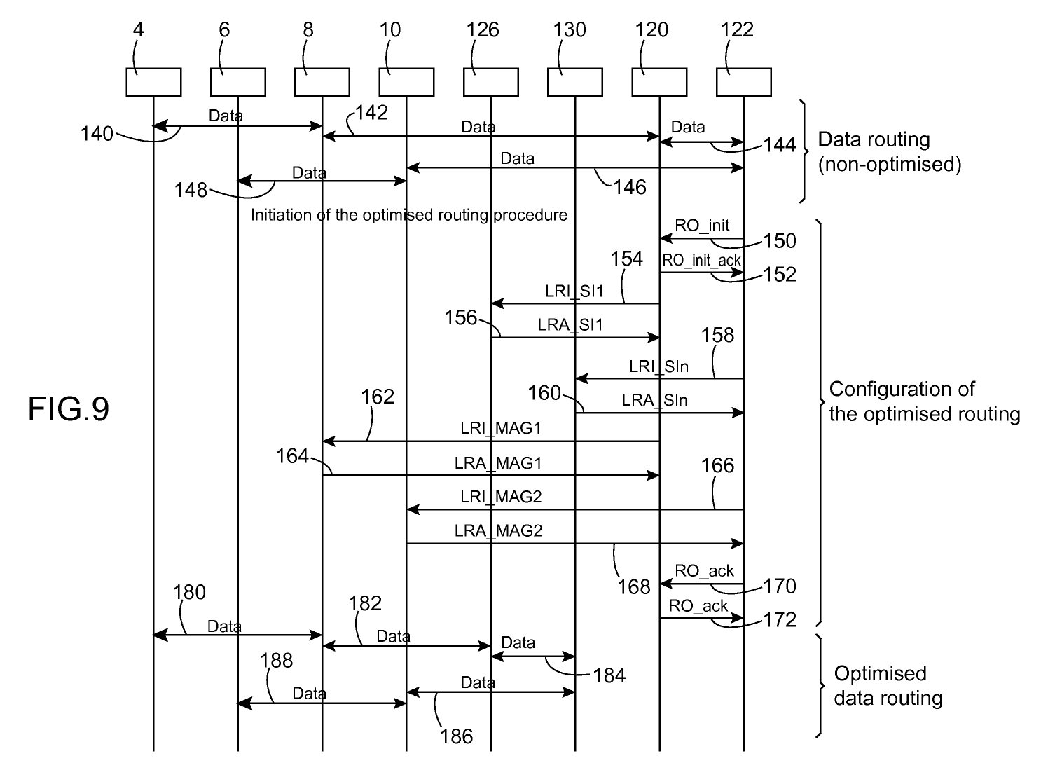

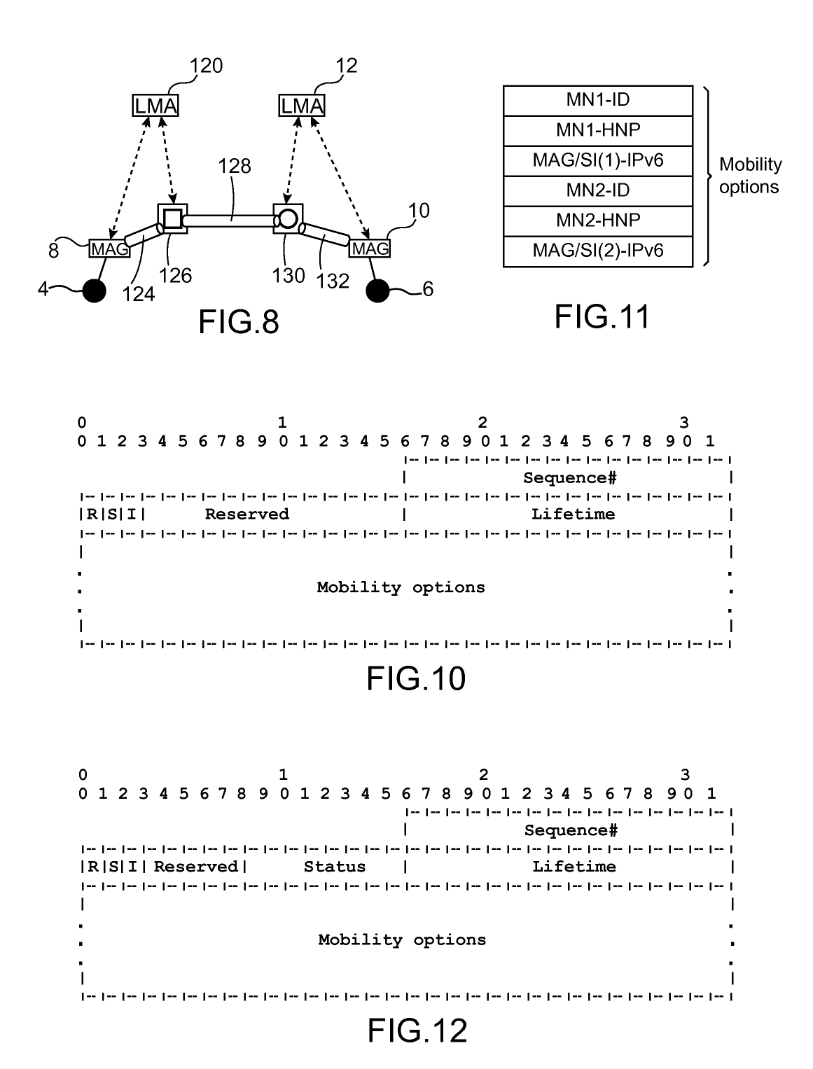

FIG. 8 diagrammatically shows one embodiment of the invention in the case where the nodes 4 and 6 which are exchanging the data flow are respectively assigned to a first LMA 120 and to a second LMA 122, which is different from the first LMA 120, belonging to two distinct PMIPv6 domains.

During a multi-media data exchange session, the MAG to which the node 4 is attached transmits the data flow through a first tunnel 124, to a first intermediate server 126 controlled by the first LMA 120. The intermediate server 126 transmits the flow received, via a second tunnel 128, to a second intermediate server 130 controlled by the second LMA 122. The second intermediate server 130 sends the flow received via a third tunnel 132 to the MAG 10 to which node 6 is attached.

The routing optimisation method may be initiated by one of the two LMAs 120 or 122. These two LMAs exchange specific information so that the input and output points of the tunnel which links the intermediate servers 126 and 130, managed respectively by these two LMAs 120 and 122, are known in advance.

FIG. 9 shows the exchanges of messages between the various elements of FIG. 8 in order to achieve optimised routing.

The steps 140 to 148 show the data exchanges before routing optimisation.

At step 140 the source node 4 sends the flow to the MAG 8 with which it is associated during the session.

At step 142 the MAG 8 sends the flow to the first LMA 120. At step 144 this latter sends said flow to the second LMA 122.

At step 146 the second LMA 122 sends the flow to the MAG 10 with which the destination node 6 is associated.

At step 148 the MAG 10 sends the flow to the destination node 6.

Steps 150 to 172 show the optimised routing configuration phase according to the invention.

At step 150, the first LMA 120 sends the second LMA 122 a message RO_init which carries information relating to the intermediate server 126.

At step 152, the second LMA 122 sends the first LMA 120 a receipt acknowledgement message RO_init_ack which carries information relating to the intermediate server 130.

At step 154, the LMA 120 sends a message LRI_SI126 to the intermediate server 126, indicating to it the prefix(es) of the source 4 and destination 6 nodes, their identifiers as well as the IPv6 address of the MAG 10 and the IPv6 address of the intermediate server 130.

At step 156, the intermediate server 126 sends the LMA 120 a message LRA_SI126 acknowledging receipt.

At step 158, the LMA 122 sends a message LRI_SI130 to the intermediate server 130, indicating to it the prefix(es) of the source 4 and destination 6 nodes, their identifiers as well as the IPv6 address of the MAG 10 and the IPv6 address of the intermediate server 126.

At step 160, the intermediate server 130 sends the LMA 122 a message LRA_SI130 acknowledging receipt.

At step 162 the LMA 120 sends a message LRI_MAG8 to the MAG 8.

At step 164, the MAG 8 sends the LMA 120 a message LRA_MAG8 acknowledging receipt.

At step 166 the LMA 122 sends a message LRI_MAG10 to the MAG 10.

At step 168, the MAG 10 sends the LMA 122 a message LRA_MAG10 acknowledging receipt.

At step 170 the first LMA 120 sends the second LMA 122 a message RO_ack confirming the setting up of the first optimised routing branch via MAG 8 and the intermediate server 126 managed by the first LMA 120.

At step 172 the second LMA 122 sends the first LMA 120 a message RO_ack confirming the setting up of the second optimised routing branch via the intermediate server 130 and the MAG 10 managed by the second LMA 122.

The steps 180 to 188 show the optimised routing steps after the routing configuration carried out by steps 150 to 172.

At step 180 the source node 4 sends the flow to the MAG 8. The latter sends (step 182) the flow received to the intermediate 126 which in turn sends it (step 184) to the intermediate server 130.

At step 186 the intermediate server 130 sends the flow to the MAG 10 which in turn sends it (step 188) to the destination node 6.

It should be noted that a system for authentication of the intermediate servers between the two PMIPv6 domains ensures authentication and protection of the exchanged data.

FIG. 10 diagrammatically shows the format of a LRI message.

This message includes:
Sequence number (16 bits): This is a number which increments linearly and which allows a message to be identified.
a bit R (1 bit): When it is at 0 it identifies the message as being an LRI.
a bit S (1 bit): When it is at 1 it requests deactivation of the local optimised routing.
a bit I (1 bit): When it is at 1 it indicates that this message is intended for an intermediate server.
A suite of Reserved bits (13 bits): Reserved field. This must be set to 0.
A set of Lifetime bits (16 bits): The time in seconds for the lifetime of the tunnel. When all bits are at 1, the period is infinite.
Mobility options: Suite of options of variable size. The LMA indicates all the information that is of use in detecting the flow from clients. The items of information that must be included are: The client 1 identifier (MN1-ID), one or more prefixes (MN1-HNP) assigned to client 1, the client 2 identifier (MN2-ID), one or more prefixes assigned to client 2 (MN2-HNP) and the IPv6 address of the MAG or of the intermediate server of the other side of the tunnel. The format of the option with the IPv6 address may be based on the format of the “MAG IPv6 address” packet. When this message is intended for an intermediate server (bit I at 1), two IPv6 addresses (for MAG or IS) associated with the MN-IDs of the two clients are supplied for the two tunnels in order to establish the routes correctly in the routing tables. The options MN-ID and MN-HNP are defined in RFC5213.

On reception of an LRI message, an intermediate server first of all verifies that the bit I is set to 1. In the event that it is not, then the message is ignored. The intermediate server then recovers the mobility options and establishes the tunnels to the MAGs and/or the ISs (intermediate servers). It is important that the options are organised in such a manner that the IS can determine how to create its two tunnels. In effect there is direction of communication which depends on where the clients are, and the IS must update its routing table correctly.

FIG. 11 shows an example in which the options are arranged in a precise order. The IS can in this case interpret the options sequentially. In this case, in order to update its routing table for the node MN1-ID, the IS considers the prefix MN1-HNP and transfers the data to the IPv6 address of the IS or MAG. Similarly for the other direction of communication (MN2-ID, etc.).

FIG. 12 diagrammatically shows the format of an LRA message.

This message includes:
A sequence number (16 bits): This is a number which increments linearly and which allows a message to be identified.
a bit R (1 bit): When it is at 1 it indicates that this is an LRA.
a bit U (1 bit): Must be set to 0.
a bit I (1 bit): When it is at 1 it indicates that it is sent by an intermediate server.
a series of Reserved bits (5 bits): Reserved field. It must be set to 0.
a series of Status bits (8 bits): When it is at 0, this field indicates a success. When the bit I is at 0 (LRA sent by a MAG), and the value of the status is equal to 129, it indicates that the client is no longer associated with the MAG. When the bit I is at 1 (LRA sent by an intermediate server), and the value of the status is equal to 129, it indicates that the operation has failed.
A series of Lifetime bits (16 bits): The time in seconds for the lifetime of the tunnel. When all bits are at 1, the period is infinite. By default, the value indicated in the LRI.
Mobility options: In all cases, the content of the same field from the LRI message in returned.

In addition to the base parameters described above, the LRI packets can include parameters for indicating to the intermediate servers and to the MAG which type of treatment is to be applied to one or more data flows. The intermediate servers can thus carry out multiple functions/services.

The LMAs can be configured to dynamically indicate to the intermediate servers (during the phase of optimised routing configuration by sending LRI messages) which services must be specifically activated for a given flow. Where the flow is also indicated in the LRI message.

The method according to the invention may be applied to other mobility management protocols. Thus in the case of Mobile IPv4 protocols [ref] and Mobile IPv6 [ref] protocols, and in particular their respective NEMOv4 [ref] and NEMOv6 [ref] extensions for the support of mobile routers, it is also important to reduce the paths followed by data between two Mobile Routers in order not to systematically pass through the Home Agent.

No extension specific to the NEMOv6 protocol has been defined to allow optimised routing (via a direct tunnel, for example) between two mobile IPv6 routers.

As regards the NEMOv4 protocol, a known extension entitled “HAARO” [ref], proposes to carry out the routing optimisation between mobile IPv4 routers. This mechanism offers direct routes (in the form of tunnels) between two mobile routers associated with a given Home Agent (HA). This solution is based on the exchange of Registration Request and Reply messages directly between two mobile routers in order to exchange the information required to establish a direct tunnel (for optimised routing) between them. This solution however, has two major drawbacks: on the one hand the implementation of optimised routing must be initiated by one of the two mobile routers, with no mechanism being envisaged for allowing initiation at the network operator's initiative (via a centralised entity). On the other hand only one direct tunnel can be established between the two mobile routers, therefore not allowing the optimised traffic to be redirected to one or more intermediate servers under the control of an operator.

In order to resolve these problems the solution described in detail previously in the context of a IPv6 domain may be applied to optimise the routing between mobile routers, thus allowing a network entity under the control of the operator, here the Home Agent (in a manner analogous to the LMA), to configure an optimised routing path which passes through intermediate servers in order to route the traffic between two mobile routers (in a manner analogous to the MAGs).

The Home Agent is therefore regarded as being the control point and is configured by the mobile network operator in order to define the optimised path (passing through intermediate servers) that the data flows must take between two mobile routers. This path may include one or more Intermediate Servers in order to implement the services in accordance with the needs of the operator.

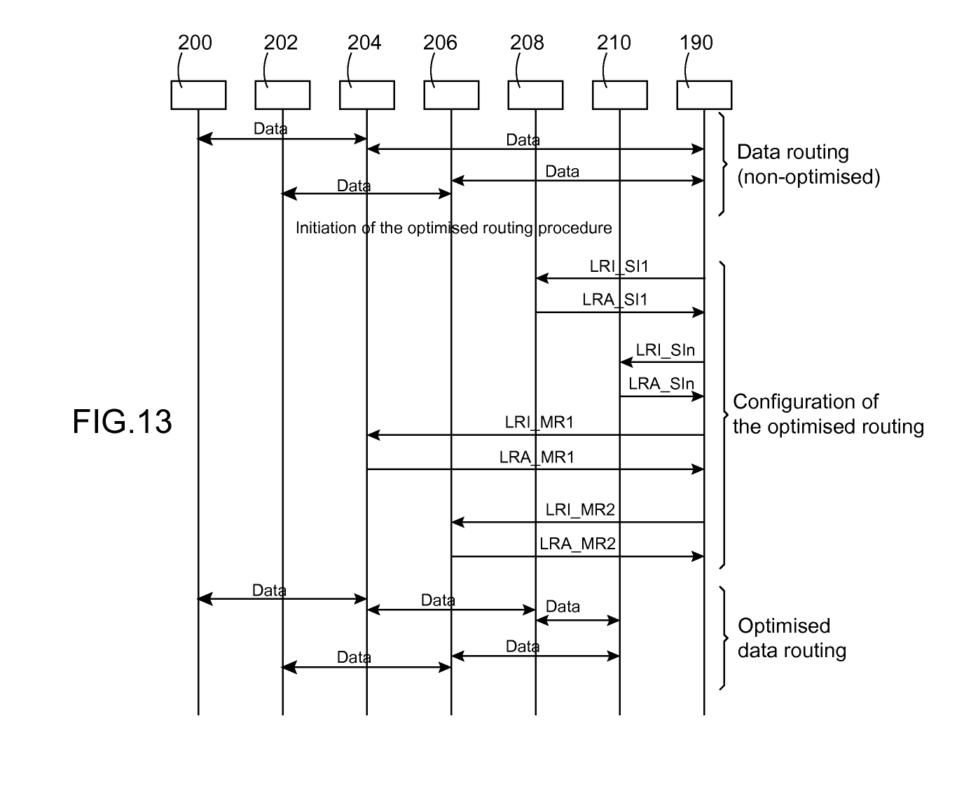

FIG. 13 shows the steps for optimising the routing between two NEMOv6 mobile routers. The exchange of messages is similar to that which is described with reference to FIG. 6, replacing the LMA12 by the HA 190 (Home Agent), the source nodes 4 and destination nodes 6 respectively by the fixed nodes LFN (Local Fixed Nodes) 200 and 202, which may be passengers' portable equipment in a moving vehicle, respectively connected to mobile routers MR 204 and 206.

In the example in FIG. 13, two intermediate servers 208 and 210 are defined by the operator.

In this context, in order to configure the optimised routing, the Home Agent 190 sends “LRI_SI” messages to the Intermediate Servers and “LRI_MR” messages to the Mobile Routers. Once these messages have been sent and cleared, the data traffic between the two mobile routers 204 and 206 will no longer pass through the HA 190, but through the optimised path passing through the Intermediate Servers 208 and 210.

In order to achieve this, the messages LRI_SI and LRI_MR include information and instructions relating to the address of Clients LFN 200 and 202 connected, respectively, to the mobile routers 204 and 206. These items of information may be grouped together in the form of a “prefix” covering several valid IPv6 addresses under a given Mobile Router (this is then referred to as a mobile network prefix, or MR-MNP—“Mobile Network Prefix of a Mobile Router”). This MR-MNP information may, for example, be carried in the LRI messages using an option which has the same format as the MN-HNP option in FIG. 10.

In a scenario in which the two mobile routers 204 and 206 are associated with different Home Agents, the two Home Agents (HA) will communicate between themselves in order to allow optimised routing to be established via intermediate servers.

Finally, the same principle may also be used to optimise the routing (via intermediate servers) between two mobile terminals which use the Mobile IPv4 and Mobile IPv6 protocols. In this case since the nodes do not truly have a prefix but only so-called “home” IP addresses, these addresses are carried in the LRI messages (instead of the MN-HNP or MR-MNP prefixes).

1. Method for optimising the routing of a flow exchanged between two nodes in a telecommunications network, procedure wherein which, during connection to the network, at least one node connects to an access router linked to a central entity which is capable of defining a path for said flow, where said procedure furthermore includes a step which involves re-routing said flow under the control of the operator, so as to make said flow pass via at least one intermediate server selected by the operator, and in order to prevent said flow from systematically passing through said central entity, a procedure characterised in the said intermediate server is arranged between said nodes and is capable of applying to said flow at least one treatment predefined by the operator which includes at least one of the following functions:
filtering the contents of the flow,
applying a tariff system to the various components of the flow,
measuring the bandwidth used,
providing differentiated quality of service, depending on the client or on the type of flow.

2. (canceled)

3. (canceled)

4. Method according to claim 1 which includes in addition a phase involving selection, by the operator, of the treatments to apply to the flow and of one or more intermediate servers capable of applying said treatments, and an optimised routing configuration phase for this flow which depends on the predefined treatments.

5. Method according to claim 4 wherein the routing configuration involves creating, between the nodes, at least one tunnel which passes through one or more intermediate servers.

6. Method according to claim 5 wherein there is defined, for each access router, a routing table optimised according to the treatments pre-defined by the operator in each intermediate server.

7. Method according to claim 6, wherein said access routers are fixed routers.

8. Method according to claim 6 wherein said access routers are mobile routers.

9. Method according to claim 7 wherein the telecommunications network is an IP type network.

10. Method according to claim 9 wherein the central entity creates the inputs and outputs of the tunnels on each intermediate server by sending each said intermediate server a signal message which includes information on the IP addresses of the nodes, the prefix(es) of the source and destination nodes, the identifiers of said source and destination nodes as well as the IP address of the previous server and the IP address of the following server.

11. Method according to claim 10 wherein the central entity retransmits said signal message if no response is received during a predefined waiting time.

12. Method according to claim 5 which furthermore includes a step for updating the tunnels following a change of association of a node to a new access router wherein said new access router stores the position of said node at an LMA (Local Mobility Anchor) on receipt of the PBU (proxy binding update) signal message.

13. Method according to claim 1 wherein the nodes and are respectively attached to a first LMA and to a second LMA which is different to the first LMA, belonging to two distinct PMIPv6 domains and, during a multimedia data exchange session, the access router to which the node is attached transmits the data flow via a first tunnel, to a first intermediate server controlled by the first LMA, the intermediate server transmits the flow received, via a second tunnel, to a second intermediate server controlled by the second LMA, the second intermediate server transmits the flow received, via a third tunnel to the access router to which the node is attached.

14. Device for optimising the routing of a flow exchanged between two nodes in a telecommunications network wherein during connection to the network, at least one node connects to an access router linked to a central entity which is capable of defining a path for said flow, which includes at least one routing table controlled by the operator which is capable of re-routing said flow in order to make it pass via at least one intermediate server selected by the operator, and in order to prevent said flow from systematically passing through said central entity, characterised in that each intermediate server includes at least one module which carries out at least one of the following functions:
filtering the contents of the flow
application of a tariff system to the various components of the flow,
measurement of the bandwidth used,
provision of differentiated quality of service, depending on the client or on the type of flow.
analysing the contents of the flows.

15. Device according to claim 14 characterised in that said central entity is capable of creating the inputs and outputs of at least one tunnel on each intermediate server by sending each intermediate server a signal message which includes information on the IP addresses of the nodes, the prefix(es) of the source and destination nodes, the identifiers of said source and destination nodes as well as the IP address of the previous server and the IP address of the following server.

16. (canceled)

17. A computer program recorded on a storage medium when it and which contains instructions for carrying out the steps in the method according to claim 1 when it is executed by computer.
